(19) United States
(12) Patent Application Publication
(10) Pub. No.: US 2006/0228200 A1
(43) Pub. Date: Oct. 12, 2006

(54) Ladder roof rack system and method of using same

(76) Inventors: John E. McLoughlin, Hauttauge, NY (US); Neocles G. Athanasiades, Setauket, NY (US); Toh K. Meng, Hauppauge, NY (US)

Correspondence Address: Frank L. Hart;Attorney at Law, 8911 S. 73rd East Ave., Tulsa, OK, 74133, US

(21) Appl. No.: 11/099,273

(22) Filed: Apr. 6, 2005

(51) Int. Cl. B60R 9/00; B60P 9/00

(52) U.S. Cl. 414/462; 224/310

(57) ABSTRACT

A roof rack system for transporting elongated objects, such as a ladder, on a tall vehicle, such as a fire truck, has first and second supports extending transversely the vehicle. An elevating system is associated with the first support to controllably raise and lower the first support. A restraining system is connected to one of the supports and is adapted to controllably restrain movement of the elongated object relative to the supports and the vehicle. A method of using the apparatus is described.

### BACKGROUND OF THE INVENTION

1. Field of the Invention

The subject invention relates to an improved roof rack system for transporting a ladder.

More particularly, the subject invention relates to mechanism associated with a roof rack system which is power operated and adapted to assist loading and unloading a ladder.

2. Description of Related Art Including Information Disclosed Under 37 CFR 1.97 and 1.98

Roof rack systems are well known in the art. They consist of first and second spaced apart supports connected to and extending transversely across the top of a vehicle. Many such systems are used with cars to maintain and transport canoes and kayaks. Other such systems are used on pickups and other vehicles to maintain and transport ladders. Ladders are also most conveniently transported on fire trucks by a roof rack system connected to the top of the fire truck.

A problem is encountered when loading and unloading ladders on the top of a vehicle, particularly a very tall vehicle such as a fire truck, for example. The ladders used by firemen are significantly more heavy than the ladders customarily used by general contractors. In addition, roof racks on the top of a fire truck are located at significantly higher elevation. This combination of weight and height demands that any loading and unloading of ladders onto and from fire trucks be undertaken by a minimum of two individuals. For a single individual to attempt to so load or unload a ladder from atop a fire truck would subject the individual to possible serious injury.

The subject invention is directed to overcome the problem of unloading ladders from elevated roof racks.

### BRIEF SUMMARY OF THE INVENTION

In one aspect of the invention, an improved roof rack system for holding an elongated object is provided. The roof rack system has first and second spaced apart supports connected to and extending transversely across the top of a vehicle. An elevating system is connected to the first support and is adapted to controllably rise and lower said support. A restraining system is connected to one of the supports and adapted to controllably restrain movement of an elongated object relative to said supports.

In another aspect of the invention, an improved roof rack system for holding an elongated object is provided in greater detail. The roof rack system has first and second spaced apart supports connected to and extending transversely across the top of a vehicle. A pressurized fluid source is provided. A fluid cylinder is connected at one end to the first support and is connectable on the other end to the vehicle. A controller is connected in fluid communication with the pressurized fluid source and the fluid cylinder. The controller is adapted to control the passage of fluid to and from the fluid cylinder. An electrically driven winch system is connected to the first support and connectable to an elongated object. The winch system is adapted to control movement of the elongated object onto and from said supports.

In yet another aspect of the invention, a method is provided for unloading an elongated object from the top of a vehicle. The roof rack first and second supports with the other apparatus of claim 1 is provided. The elevating system is actuated to raise the first support and associated elongated object. Then restraining system is then actuated allowing the elongated object to move along and outwardly from the vehicle.

In a further aspect of the invention, a method is provided for loading an elongated object onto the top of a vehicle the roof rack first and second supports are provided with the other apparatus of claim 1. The restraining system is connected to the elongated object. Then the restraining system is actuate and pulls the elongated object onto the vehicle in response thereto.

### BRIEF DESCRIPTION OF THE SEVERAL VIEWS OF THE DRAWING(S)

FIG. 1 is a plan view of the top of a vehicle having a roof rack system which has the apparatus of this invention;

FIG. 2 is a side view of a portion of a vehicle having one embodiment of the apparatus of this invention;

FIG. 3 is a side view of a portion of a vehicle having another embodiment of the apparatus of this invention.

FIG. 4 is a side view of a portion of a vehicle having a restraining system of different construction.

### DETAILED DESCRIPTION OF THE INVENTION

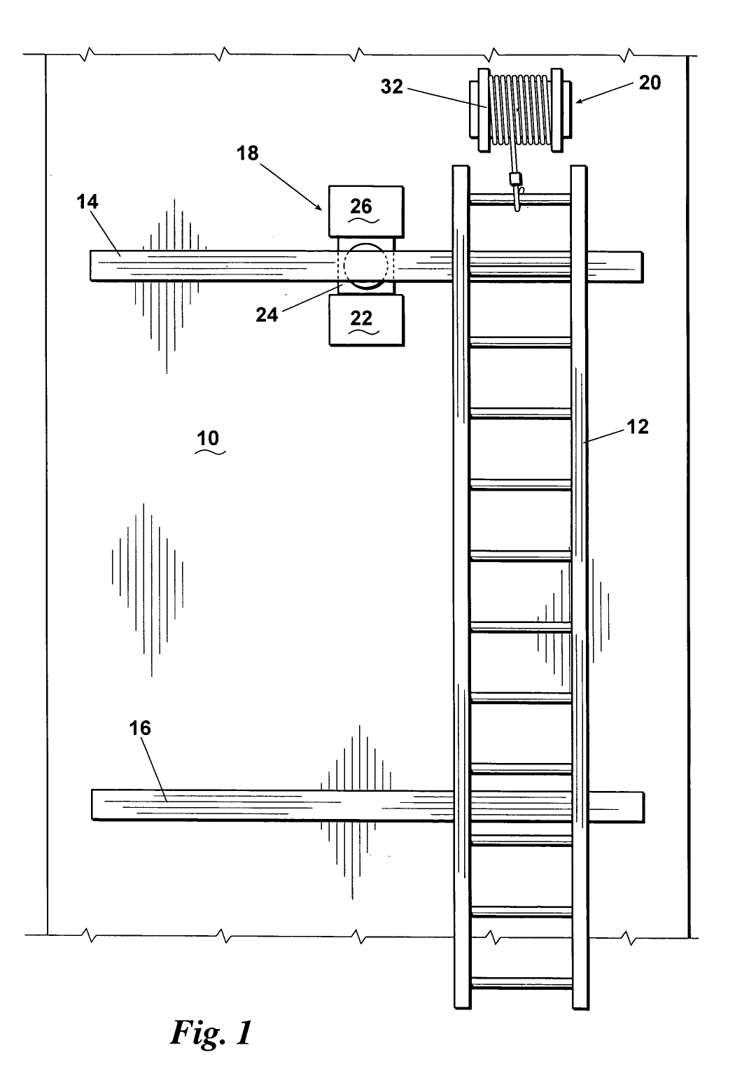

Referring to FIG. 1, a vehicle 10 such as a fire truck, for example, has a roof rack system for maintaining and transporting an elongated object 12, such as a ladder for example. For simplicity and ease of understanding, the vehicle 10 will generally be referred to as a fire truck and the elongated object will generally be referred to as a ladder. The roof rack system, as known in the art, has first and second spaced apart supports 14,16 which are connected to and extend transversely across the top of the vehicle 10.

Preferably, the first support 14 is adjacent a front of the fire truck 10, but it will not depart from this invention for the first support 14 to be adjacent the rear of the vehicle 10. With the configuration of trucks differing, a ladder may be more easily loaded from the rear, while with another truck, the ladder may be more easily loaded from the front.

An elevating system 18 is connected to the first support 14 and adapted to controllably raise and lower said support 14 relative to the vehicle 10. A restraining system 20 is connected to one of the supports 14 and is adapted to controllably restrain movement of the ladder 12 relative to the supports 14,16 and the vehicle 10.

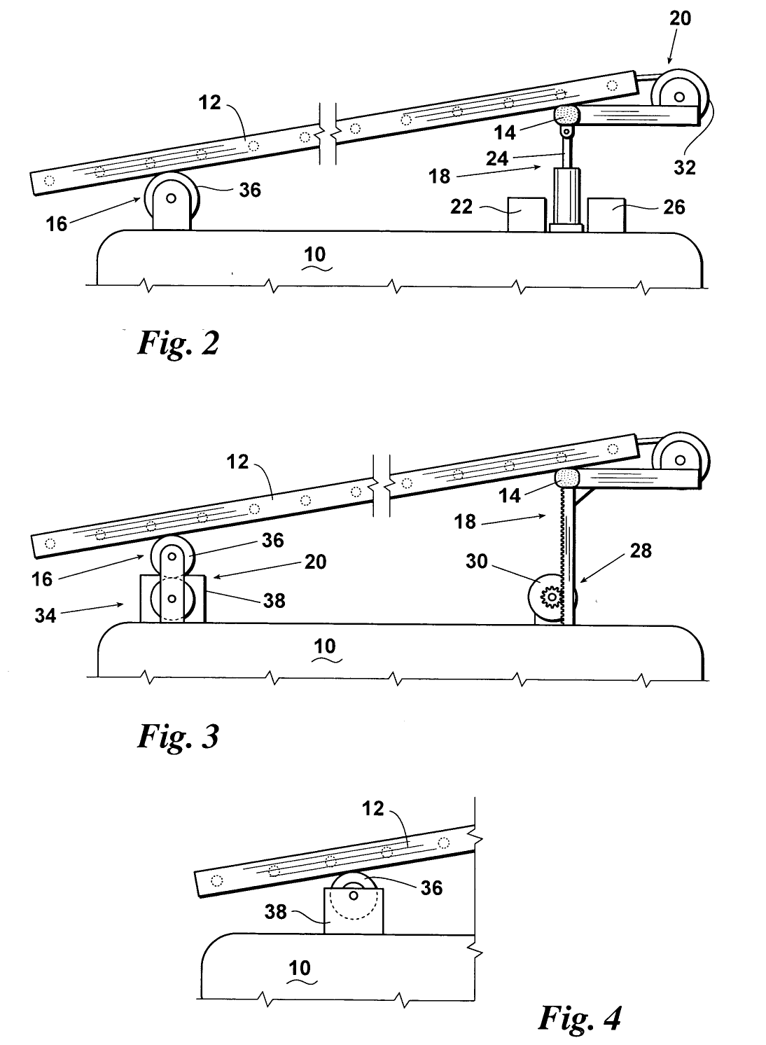

In the embodiment shown in FIGS. 1 and 2, the elevating system 18 includes a pressurized fluid source 22, a fluid cylinder 24, and a controller 26. The fluid cylinder 24 is connected at one end to said first support 14 and is connectable on the other end to the vehicle 10. The controller 16 is in fluid communication with the pressurized fluid source 22 and the fluid cylinder 24. The controller 16 is adapted to control the passage of fluid to and from the fluid cylinder 24 which responsively raises and lowers the elevation of the first support 14 relative to the vehicle 10.

In the preferred embodiment, the elevating system 18 is a hydraulic cylinder. Without departing from this invention, the elevating system 18 can be a pneumatic cylinder or, as shown in FIG. 3, a rack and pinion gearing system 28 connected to the first support 14 and to an electric motor 30 or a spring and fluid actuating system.

As shown in FIGS. 1 and 2, the preferred restraining system 20 is a electrically driven winch system 32 as is well known in the art. The winch system 32 is connected to the first support 14, is connectable to the ladder 12 and is adapted to control the movement of the ladder in directions onto and from said supports 14,16.

FIG. 3 shows another embodiment of the restraining system 20 which includes a friction system which has a roller 36 connected to and extending transverse the vehicle and in rolling contact with the ladder 12 movement of the ladder 12 on and off the vehicle 10. In this embodiment, the roller 36 functions as the second support 16. Power means 38 is connected to the vehicle and to the roller 36 and is adapted to controllably drive the roller in first and second directions. The power means 38 preferably is an electric motor.

Referring to FIG. 1, the first support 14 is an elongated bar. FIG. 2 shows the first support 14 as a first roller 36. FIG. 3 shows the restraining system 20 as a friction system 34, as preferred and as described above. FIG. 4 shows the restraining system 20 as a single roller having power means 38.

In the operation of the apparatus of this invention, a single individual can load a ladder 12 on and remove a ladder 12 from a tall vehicle 10 such as a fire truck.

An individual can remove a ladder 10, or other elongate apparatus 12, from the top of the vehicle 10 by providing roof rack first and second supports 14,16 with the apparatus of claim 1, energizing the elevating system 18 and raising the first support 14 and associated elongated object 12 in response thereto, and actuating the restraining system 20 and allowing the elongated object 12 to move along and outwardly from the vehicle 10.

An individual can load an elongated object 12 onto the top of a vehicle 10 by providing the roof rack first and second supports 14,16 with the apparatus of claim 1, connecting the restraining system 20 to the elongated object 12;,and actuating the restraining system 20 and pulling the elongated object 12 onto the vehicle 10 in response thereto.

Other aspects, objects, and advantages will become apparent from a study of the drawings, the specification and the appended claims.

1. In a roof rack system for holding an elongated object, said system having first and second spaced apart supports connected to and extending transversely across the top of a vehicle, the improvement comprising:
an elevating system connected to the first support and being adapted to controllably raise and lower said support; and
a restraining system connected to one of the supports and connectable to an elongated object and being adapted to controllably restrain movement of the elongated object relative to said supports.

2. A roof rack system, as set forth in claim 1, wherein the elevating system includes:
a pressurized fluid source;
a fluid cylinder being connected at one end to said first support and being connectable on the other end to the vehicle;
a controller connected in fluid communication with said pressurized fluid source and said fluid cylinder and adapted to control the passage of fluid to and from said fluid cylinder.

3. A roof rack system, as set forth in claim 1, wherein the restraining system includes an electrically driven winch system being connected to the first support, connectable to an elongated object and adapted to control movement of the elongated object in directions onto and from said supports.

4. A roof rack system as set forth in claim 1, wherein the restraining system includes:
a friction roller system having a first roller connected to and extending transverse a vehicle and being rollingly contactable with an elongated object; and
power means connected to the vehicle and to the roller and being adapted to controllably drive the roller in first and second directions.

5. A roof rack system, as set forth in claim 1, including a roller extending along and being connected to the second support, said roller being rollingly contactable with an elongated object during movement of the elongated object onto and from the roof rack system.

6. A roof rack system, as set forth in claim 1, wherein the fluid cylinder is a hydraulic cylinder.

7. A roof rack system, as set forth in claim 1, wherein the fluid cylinder is a pneumatic cylinder.

8. A roof rack system, as set forth in claim 1, wherein the elevating system includes:
an electric motor; and
a rack and pinion gearing system connectable to the electric motor.

9. In a roof rack system for holding an elongated object, said system having first and second spaced apart supports connected to and extending transversely across the top of a vehicle, the improvement comprising:
a pressurized fluid source;
a fluid cylinder connected at one end to said first support and being connectable on the other end to the vehicle;
a controller connected in fluid communication with said pressurized fluid source and said fluid cylinder and being adapted to control the passage of fluid to and from said fluid cylinder; and
an electrically driven winch system connected to the first support, connectable to an elongated object, and adapted to control movement of the elongated object in directions onto and from said supports.

10. A roof rack system, as set forth in claim 9, wherein the fluid cylinder is a hydraulic cylinder.

11. A roof rack system, as set forth in claim 9, wherein the fluid cylinder is a pneumatic cylinder.

12. A method for unloading a elongated object from the top of a vehicle, comprising:
providing roof rack first and second supports with the apparatus of claim 1;
actuating the elevating system and raising the first support and associated elongated object; and
actuating the restraining system and allowing the elongated object to move along and outwardly from the vehicle.

13. A method for loading an elongated object onto the top of a vehicle, comprising:
providing roof rack first and second supports with the apparatus of claim 1;
connecting the restraining system to the elongated member; and
actuating the restraining system and pulling the elongated object onto the vehicle in response thereto.
